(19) United States
(12) Patent Application Publication
(10) Pub. No.: US 2022/0082744 A1
(43) Pub. Date: Mar. 17, 2022

(54) Optical Filter and Electronic Device

(71) Applicant: Seiko Epson Corporation, Tokyo (JP)

(72) Inventor: Tomoaki NAKAMURA, Shiojiri (JP)

(21) Appl. No.: 17/476,542

(22) Filed: Sep. 16, 2021

(30) Foreign Application Priority Data
Sep. 17, 2020 (JP) 2020-156505

(51) Int. Cl. G02B 5/28; G01J 3/02; G01J 3/26

(52) U.S. Cl. CPC G02B 5/28; G01J 2003/2859; G01J 3/26; G01J 3/0229

(57) ABSTRACT

An optical filter includes: a first filter including a pair of first reflective films facing each other via a first gap and a first actuator changing a gap between the pair of first reflective films; and a second filter including a pair of second reflective films facing each other via a second gap and a second actuator changing a gap between the pair of second reflective films with the pair of second reflective films disposed on an optical path of light transmitted through the pair of first reflective films, in which each of the first reflective film and the second reflective film is configured by a plurality of optical bodies being laminated, the optical body has reflection characteristics of reflecting light centered on a predetermined design center wavelength, and the design center wavelength is different in each of the optical bodies.

The present application is based on, and claims priority from JP Application Serial Number 2020-156505, filed Sep. 17, 2020, the disclosure of which is hereby incorporated by reference herein in its entirety.

### BACKGROUND

### 1. Technical Field

The present disclosure relates to an optical filter and an electronic device.

### 2. Related Art

A Fabry-Perot-type optical filter (tunable interference filter) is known in the related art (see, for example, JP-A-2018-112750).

In the tunable interference filter described in JP-A-2018-112750, a fixed mirror provided on a fixed substrate and a movable mirror provided on a movable substrate are disposed so as to face each other via a gap. In this tunable interference filter, the gap dimension between the fixed mirror and the movable mirror can be changed by an electrostatic actuator and the light that is transmitted through the tunable interference filter changes by the gap dimension being changed.

In addition, exemplified in the tunable interference filter of JP-A-2018-112750 are those using a dielectric multilayer film, a metal alloy film, and a metal film as the fixed mirror and the movable mirror.

However, an optical filter as described in JP-A-2018-112750 and an electronic device such as a measuring device provided with the optical filter are problematic in that a wide measurement wavelength range allowing measurement and a high level of spectroscopic measurement accuracy are incompatible. In other words, when a dielectric multilayer film is used as a fixed mirror and a movable mirror in an optical filter as described in JP-A-2018-112750, a problem arises as the spectroscopic measurement wavelength range becomes narrow although light of a target wavelength can be transmitted with high wavelength resolution. Meanwhile, when a metal alloy film or a metal film is used as the fixed mirror and the movable mirror, a problem arises as the wavelength resolution is lower than in the case of a dielectric multilayer film and a decline in spectroscopic measurement accuracy occurs although spectroscopy can be performed with respect to a wide wavelength range from the visible light range to the infrared range.

### SUMMARY

An optical filter according to a first aspect of the present disclosure includes: a first filter including a pair of first reflective films facing each other via a first gap and a first actuator changing a gap between the pair of first reflective films; and a second filter including a pair of second reflective films facing each other via a second gap and a second actuator changing a gap between the pair of second reflective films with the pair of second reflective films disposed on an optical path of light transmitted through the pair of first reflective films, in which each of the first reflective film and the second reflective film is configured by a plurality of optical bodies being laminated, the optical body has reflection characteristics of reflecting light centered on a predetermined design center wavelength, and the design center wavelength is different in each of the optical bodies.

An electronic device according to a second aspect of the present disclosure includes: the optical filter according to the first aspect; and a controller controlling the first actuator and the second actuator, in which the controller controls the first actuator such that a first peak wavelength as one of a plurality of peak wavelengths transmitted through the first filter is included in a target wavelength range centered on a desired target wavelength and controls the second actuator such that a second peak wavelength as one of a plurality of peak wavelengths transmitted through the second filter is included in the target wavelength range and a peak wavelength other than the first peak wavelength transmitted through the first filter and a peak wavelength other than the second peak wavelength transmitted through the second filter are different from each other.

### BRIEF DESCRIPTION OF THE DRAWINGS

FIG. 1 is a diagram illustrating a schematic configuration of the spectroscopic measuring device of a first embodiment.

FIG. 2 is a cross-sectional view schematically illustrating a schematic configuration of a first filter of the first embodiment.

FIG. 3 is a cross-sectional view illustrating an outline of a reflective film configuration of the first filter of the first embodiment.

FIG. 4 is a cross-sectional view schematically illustrating a schematic configuration of a second filter of the first embodiment.

FIG. 5 is a cross-sectional view illustrating an outline of the reflective film configuration of the second filter of the first embodiment.

FIG. 6 is a flowchart showing a spectroscopic measurement method using the spectroscopic measuring device of the first embodiment.

FIG. 7 is a diagram illustrating an example of the spectral characteristics of the first filter, the spectral characteristics of the second filter, and the transmission characteristics of light transmitted through an optical filter in the first embodiment.

FIG. 8 is a diagram illustrating an example of the spectral characteristics of the first filter, the spectral characteristics of the second filter, and the transmission characteristics of the light transmitted through the optical filter in the first embodiment.

FIG. 9 is a diagram illustrating an example of the spectral characteristics of the first filter, the spectral characteristics of the second filter, and the transmission characteristics of the light transmitted through the optical filter in the first embodiment.

FIG. 10 is a diagram illustrating an example of the spectral characteristics of the first filter, the spectral characteristics of the second filter, and the transmission characteristics of the light transmitted through the optical filter in the first embodiment.

FIG. 11 is a diagram illustrating the relationship between the difference between first and second peak wavelengths and light transmitted through an optical filter with a target wavelength.

FIG. 12 is a cross-sectional view illustrating a film configuration of a first movable reflective film and a first fixed reflective film of a second embodiment.

FIG. 13 is a cross-sectional view illustrating the film configuration of a second movable reflective film and a second fixed reflective film of the second embodiment.

### DESCRIPTION OF EXEMPLARY EMBODIMENTS

### First Embodiment

Hereinafter, a first embodiment will be described.

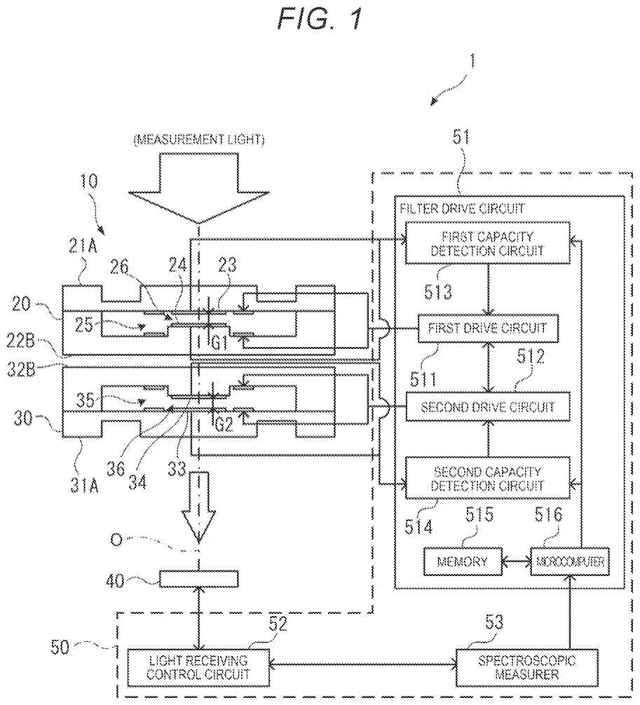

FIG. 1 is a diagram illustrating a schematic configuration of a spectroscopic measuring device 1 of the first embodiment.

### Overall Configuration of Spectroscopic Measuring Device 1

The spectroscopic measuring device 1 is an electronic device that disperses measurement light incident from a measurement object and measures the spectral spectrum, chromaticity, and so on of the measurement object. As illustrated in FIG. 1, the spectroscopic measuring device 1 is configured to include an optical filter 10, a light receiver 40, and a controller 50.

In addition, as illustrated in FIG. 1, the optical filter 10 includes a first filter 20 and a second filter 30.

### Configuration of First Filter 20

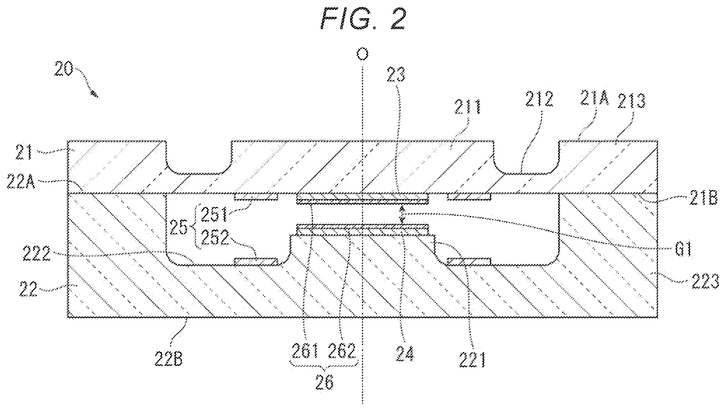

FIG. 2 is a cross-sectional view schematically illustrating a schematic configuration of the first filter 20.

The first filter 20 is a Fabry-Perot-type tunable interference filter and includes a light-transmitting first movable substrate 21 and a light-transmitting first fixed substrate 22. The first movable substrate 21 and the first fixed substrate 22 are disposed along an optical axis O of the light receiver 40.

The first movable substrate 21 is provided with a first movable reflective film 23 as one of a pair of first reflective films, and the first fixed substrate 22 is provided with a first fixed reflective film 24 as the other of the pair of first reflective films. In addition, the first filter 20 includes a first actuator 25 as a first gap changer changing the dimension between the first movable reflective film 23 and the first fixed reflective film 24. The first actuator 25 is an electrostatic actuator configured by a first electrode 251 provided on the first movable substrate 21 and a second electrode 252 provided on the first fixed substrate 22.

The first movable substrate 21 has a first surface 21A where the measurement light is incident and a second surface 21B facing the first fixed substrate 22. In the first movable substrate 21, a diaphragm portion 212 as a substantially annular concave groove is formed by the first surface 21A being etched. In addition, the region that is surrounded by the diaphragm portion 212 constitutes a movable portion 211. The movable portion 211 is held by the diaphragm portion 212 so as to be movable in the direction from the first movable substrate 21 toward the first fixed substrate 22.

Further, the second surface 21B of the movable portion 211 is provided with the first movable reflective film 23. It should be noted that the configuration of the first movable reflective film 23 will be described in detail later.

In addition, a first detection electrode 261 as a transparent electrode is provided on the first gap G1 side of the first movable reflective film 23. IGO, ITO, and so on can be used as the transparent electrode.

Further, the first electrode 251 is disposed on the second surface 21B of the first movable substrate 21 so as to surround the first movable reflective film 23. The first electrode 251 may be provided on the movable portion 211 or may be provided on the diaphragm portion 212. A configuration in which the first electrode 251 is provided on the movable portion 211 is exemplified in the present embodiment.

The outer side of the diaphragm portion 212 of the first movable substrate 21 constitutes an outer peripheral portion 213, which is larger in thickness along the optical axis O than the diaphragm portion 212. The outer peripheral portion 213 is joined to the first fixed substrate 22 via a joining member (not illustrated).

The first fixed substrate 22 includes a third surface 22A facing the first movable substrate 21 and a fourth surface 22B facing the second filter 30.

In the first fixed substrate 22, a mirror base 221 facing the movable portion 211, a groove portion 222 provided outside the mirror base 221, and a base portion 223 provided outside the groove portion 222 are formed by the third surface 22A being processed by etching or the like.

The mirror base 221 is a part where the first fixed reflective film 24 facing the first movable reflective film 23 via the first gap G1 is provided.

In addition, a second detection electrode 262 as a transparent electrode is provided on the first gap G1 side of the first fixed reflective film 24. The second detection electrode 262 faces the first detection electrode 261 via the first gap G1 and constitutes a first capacitance detector 26 together with the first detection electrode 261. In other words, in the present embodiment, the dimension of the first gap G1 can be detected by the electric charge changing that is held by the first detection electrode 261 and the second detection electrode 262.

The groove portion 222 is a part provided so as to face the first electrode 251, and the second electrode 252 disposed so as to face the first electrode 251 is disposed at this part. The second electrode 252 constitutes the first actuator 25 together with the first electrode 251 as described above, and the second electrode 252 displaces the movable portion 211 to the first fixed substrate 22 side by electrostatic attraction by a drive voltage being applied between the first electrode 251 and the second electrode 252.

The base portion 223 is a part that is joined to the outer peripheral portion 213 of the first movable substrate 21 via a joining member.

It should be noted that the first filter 20 is provided with a drive terminal (not illustrated) electrically coupled to each of the first electrode 251 and the second electrode 252 of the first actuator 25 and a detection terminal (not illustrated) electrically coupled to each of the first detection electrode 261 and the second detection electrode 262. These terminals are coupled to the controller 50, and a drive voltage is applied to the first actuator 25 and the dimension of the first gap G1 is detected using a capacitance detector under the control of the controller 50.

It should be noted that an electrostatic actuator is exemplified as the first actuator 25 in the present embodiment and yet the present disclosure is not limited thereto. In an alternative configuration of the first actuator 25, the dimension between the first movable substrate 21 and the first fixed substrate 22, that is, the first gap G1 between the first movable reflective film 23 and the first fixed reflective film 24 may be changed by voltage application to a piezoelectric element with the piezoelectric element disposed between the first movable substrate 21 and the first fixed substrate 22.

### Configuration of First Movable Reflective Film 23 and First Fixed Reflective Film 24

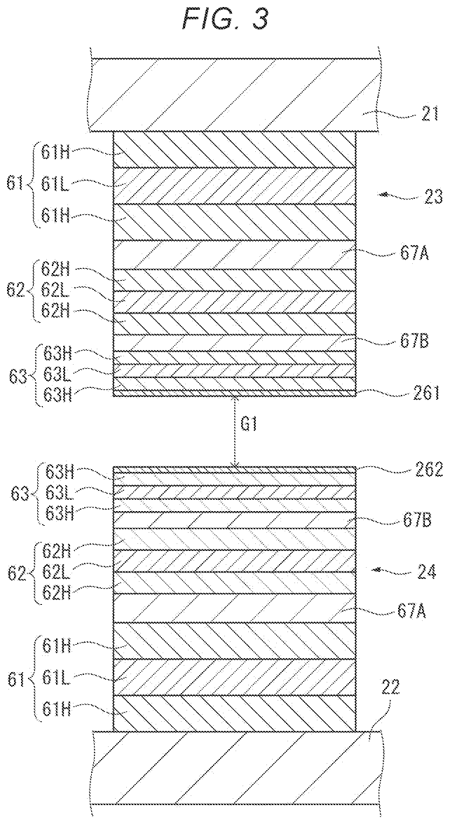

FIG. 3 is a diagram illustrating a schematic configuration of the first movable reflective film 23 and the first fixed reflective film 24 in the first filter 20 of the first embodiment.

The first movable reflective film 23 is configured by a plurality of laminated bodies (optical bodies) being laminated from the first movable substrate 21 toward the first gap G1. In addition, the first fixed reflective film 24 is identical in configuration to the first movable reflective film 23 and is configured by a plurality of laminated bodies (optical bodies) being laminated from the first fixed substrate 22 toward the first gap G1.

In the example illustrated in FIG. 3, a first laminated body 61, a second laminated body 62, and a third laminated body 63 are provided as the plurality of laminated bodies. The first laminated body 61 is laminated on the first movable substrate 21 or the first fixed substrate 22. The third laminated body 63 is disposed at the position that is closest to the first gap G1 in the first movable reflective film 23 and the first fixed reflective film 24. The second laminated body 62 is disposed between the first laminated body 61 and the third laminated body 63.

It should be noted that an example in which the first movable reflective film 23 and the first fixed reflective film 24 are configured to include three laminated bodies as described above is illustrated in the example of FIG. 3 and yet a configuration including four or more laminated bodies, a configuration including two laminated bodies, and so on may be used instead.

Each of the laminated bodies is a dielectric multilayer film configured by high-refractive and low-refractive layers being alternately laminated and has light reflection characteristics centered on a predetermined design center wavelength. For example, in the first laminated body 61, a first high-refractive layer 61H, a first low-refractive layer 61L, and the first high-refractive layer 61H are alternately laminated in this order from the first movable substrate 21 or the first fixed substrate 22. Likewise, a second high-refractive layer 62H, a second low-refractive layer 62L, and the second high-refractive layer 62H are alternately laminated in this order from the first laminated body 61 side in the second laminated body 62 and a third high-refractive layer 63H, a third low-refractive layer 63L, and the third high-refractive layer 63H are alternately laminated in this order from the second laminated body 62 side in the third laminated body 63.

In the following description, the refractive index of the first high-refractive layer 61H is n_{1H}, the thickness of the first high-refractive layer 61H is d_{1H}, the refractive index of the first low-refractive layer 61L is n_{1L}, and the thickness of the first low-refractive layer 61L is d_{1L}. The refractive index of the second high-refractive layer 62H is n_{2H}, the thickness of the second high-refractive layer 62H is d_{2H}, the refractive index of the second low-refractive layer 62L is n_{2L}, and the thickness of the second low-refractive layer 62L is d_{2L}. The refractive index of the third high-refractive layer 63H is n_{3H}, the thickness of the third high-refractive layer 63H is d_{3H}, the refractive index of the third low-refractive layer 63L is n_{3L}, and the thickness of the third low-refractive layer 63L is d_{3L}.

The first laminated body 61 is a dielectric multilayer film that reflects light centered on a first design center wavelength Ai. In other words, in the first laminated body 61, the first high-refractive layer 61H and the first low-refractive layer 61L have the same optical film thickness (first optical film thickness). Specifically, the first optical film thickness of the first high-refractive layer 61H and the first low-refractive layer 61L satisfies n_{1H}×d_{1H}=n_{1L}×d_{1L}=λ₁/4.

The second laminated body 62 is a dielectric multilayer film that reflects light centered on a second design center wavelength λ₂. In other words, in the second laminated body 62, the second high-refractive layer 62H and the second low-refractive layer 62L have the same optical film thickness (second optical film thickness). Specifically, the second optical film thickness of the second high-refractive layer 62H and the second low-refractive layer 62L satisfies n_{2H}×d_{2H}=n_{2L}×d_{2L}=λ₂/4. Here, the second design center wavelength λ₂ satisfies the relationship of λ₁>λ₂.

Likewise, the third laminated body 63 is a dielectric multilayer film that reflects light centered on a third design center wavelength λ₃. In other words, in the third laminated body 63, the third high-refractive layer 63H and the third low-refractive layer 63L have the same optical film thickness (third optical film thickness). Specifically, the third optical film thickness of the third high-refractive layer 63H and the third low-refractive layer 63L satisfies n_{3H}×d_{3H}=n_{3L}×d_{3L}=λ₃/4. Here, the third design center wavelength λ₃ satisfies the relationship of λ₁>λ₂>λ₃.

The first design center wavelength λ₁, the second design center wavelength λ₂, and the third design center wavelength λ₃ are set in accordance with the wavelength range to be measured by the spectroscopic measuring device 1 (hereinafter, referred to as the measurement wavelength range). For example, λ₁ is set to 950 nm, λ₂ is set to 600 nm, and λ₃ is set to 400 nm as an example of a case where the measurement wavelength range (400 nm to 1,000 nm) is from the visible light range to the near infrared wide range. It should be noted that an example in which the wavelength interval between the first design center wavelength λ₁ and the second design center wavelength λ₂ is larger than the wavelength interval between the second design center wavelength λ₂ and the third design center wavelength λ₃ is illustrated and yet the present disclosure is not limited thereto. For example, the wavelength interval between the first design center wavelength λ₁ and the second design center wavelength λ₂ and the wavelength interval between the second design center wavelength λ₂ and the third design center wavelength λ₃ may be equal to each other. The first filter 20 of the present embodiment transmits light containing a plurality of peak wavelengths in the measurement wavelength range, which will be described in detail later. The wavelength interval between the first design center wavelength λ₁ and the second design center wavelength λ₂ and the wavelength interval between the second design center wavelength λ₂ and the third design center wavelength λ₃ may be set such that the intervals between the peak wavelengths are substantially uniform.

In addition, the first laminated body 61 and the second laminated body 62 are connected via a light-transmitting first connecting layer 67A and the second laminated body 62 and the third laminated body 63 are connected via a light-transmitting second connecting layer 67B.

The first connecting layer 67A has a refractive index n₇ₐ and a film thickness d₇ₐ, and the optical film thickness of the first connecting layer 67A is an optical film thickness based on the average of the first design center wavelength and the second design center wavelength. In other words, assuming that the design center wavelength of the first connecting layer 67A is λ₇ₐ, the design center wavelength λ₇ₐ is λ₇ₐ=(λ₁+λ₂)/2 and satisfies n₇ₐ×d₇ₐ=λ₇ₐ/4.

The second connecting layer 67B has a refractive index n_{7b} and a film thickness d_{7b}, and the optical film thickness of the second connecting layer 67B is an optical film thickness based on the average of the second design center wavelength and the third design center wavelength. In other words, assuming that the design center wavelength of the second connecting layer 67B is λ_{7b}, the design center wavelength λ_{7b} is λ_{7b}=(λ₂+λ₃)/2 and satisfies n_{7b}×d_{7b}=λ_{7b}/4.

To further describe the present embodiment with a specific example, the first high-refractive layer 61H, the second high-refractive layer 62H, and the third high-refractive layer 63H are made of the same material in the first movable reflective film 23 and the first fixed reflective film 24. In addition, the first low-refractive layer 61L, the second low-refractive layer 62L, and the third low-refractive layer 63L are made of the same material.

In addition, in the present embodiment, the layer of the first laminated body 61 that is disposed closest to the second laminated body 62 side is the first high-refractive layer 61H and the layer of the second laminated body 62 that is disposed closest to the first laminated body 61 side is the second high-refractive layer 62H. Likewise, the layer of the second laminated body 62 that is disposed closest to the third laminated body 63 side is the second high-refractive layer 62H and the layer of the third laminated body 63 that is disposed closest to the second laminated body 62 side is the third high-refractive layer 63H. In this case, it is preferable to use low-refractive layers as the first connecting layer 67A and the second connecting layer 67B and, for example, the same material as the first low-refractive layer 61L, the second low-refractive layer 62L, and the third low-refractive layer 63L can be used.

In this case, n_{1H}=n_{2H}=n_{3H} and n_{1L}=n_{2L}=n_{3L}=n₇ₐ=n_{7b} are satisfied, and thus the optical film thickness of each of the laminated bodies 61, 62, and 63 and the connecting layers 67A and 67B can be set simply with the thickness of each layer.

It should be noted that the optical film thickness of the first detection electrode 261 provided on the first movable reflective film 23 and the optical film thickness of the second detection electrode 262 provided on the first fixed reflective film 24 are sufficiently smaller than the optical film thickness of each layer constituting each of the laminated bodies 61, 62, and 63. For example, in the present embodiment, the first detection electrode 261 and the second detection electrode 262 are configured by IGO and are formed so as to, for example, have a film thickness of approximately 10 nm at an optical film thickness of 20 nm.

### Configuration of Second Filter 30

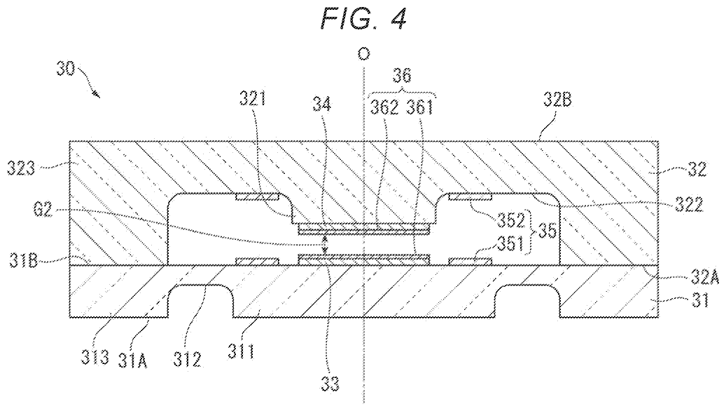

FIG. 4 is a cross-sectional view schematically illustrating a schematic configuration of the second filter 30.

The second filter 30 is a Fabry-Perot-type tunable interference filter and is substantially identical in configuration to the first filter 20. In other words, the second filter 30 includes a light-transmitting second movable substrate 31 and a light-transmitting second fixed substrate 32. The second movable substrate 31 and the second fixed substrate 32 are disposed along the optical axis O of the light receiver 40.

The second movable substrate 31 is provided with a second movable reflective film 33 as one of a pair of second reflective films, and the second fixed substrate 32 is provided with a second fixed reflective film 34 as the other of the pair of second reflective films. In addition, the second filter 30 includes a second actuator 35 as a second gap changer changing the dimension between the second movable reflective film 33 and the second fixed reflective film 34. The second actuator 35 is configured by an electrostatic actuator as in the case of the first actuator 25 and includes a third electrode 351 provided on the second movable substrate 31 and a fourth electrode 352 provided on the second fixed substrate 32.

The second movable substrate 31 has a fifth surface 31A on the side that faces the light receiver 40 and a sixth surface 31B facing the second fixed substrate 32. The second movable substrate 31 is substantially identical in configuration to the first movable substrate 21. In other words, in the second movable substrate 31, a second diaphragm portion 312 as a substantially annular concave groove and a second movable portion 311 surrounded by the second diaphragm portion 312 are formed by the fifth surface 31A being etched. In addition, the sixth surface 31B of the second movable portion 311 is provided with the second movable reflective film 33. The second movable reflective film 33 is configured by a plurality of laminated bodies (optical bodies) being laminated as in the case of the first movable reflective film 23 and the first fixed reflective film 24.

In addition, the third electrode 351 constituting the second actuator 35 is disposed on the sixth surface 31B of the second movable substrate 31 so as to surround the second movable reflective film 33.

The outer side of the second diaphragm portion 312 of the second movable substrate 31 constitutes a second outer peripheral portion 313, which is larger in thickness along the optical axis O than the second diaphragm portion 312, and is joined to the second fixed substrate 32 via a joining member (not illustrated).

The second fixed substrate 32 includes a seventh surface 32A facing the second movable substrate 31 and an eighth surface 32B facing the first filter 20.

As in the case of the first fixed substrate 22, in the second fixed substrate 32, a second mirror base 321, a second groove portion 322, and a second base portion 323 are formed by the seventh surface 32A being processed by etching or the like.

The second mirror base 321 is a part where the second fixed reflective film 34 facing the second movable reflective film 33 via a second gap G2 is provided. The second fixed reflective film 34 is configured by a plurality of laminated bodies (optical bodies) being laminated as in the case of the second movable reflective film 33, the first movable reflective film 23, and the first fixed reflective film 24.

A fourth detection electrode 362 as a transparent electrode is provided on the second gap G2 side of the second fixed reflective film 34. The fourth detection electrode 362 faces a third detection electrode 361 via the second gap G2 and constitutes a second capacitance detector 36 together with the third detection electrode 361. In other words, in the present embodiment, the dimension of the second gap G2 can be detected by the electric charge changing that is held by the third detection electrode 361 and the fourth detection electrode 362.

The second groove portion 322 is provided so as to face the third electrode 351, and the fourth electrode 352 is disposed in the second groove portion 322. The fourth electrode 352 constitutes the second actuator 35 together with the third electrode 351 as described above, and the fourth electrode 352 displaces the second movable portion 311 to the second fixed substrate 32 side.

The second base portion 323 is a part that is joined to the second outer peripheral portion 313 of the second movable substrate 31 via a joining member.

It should be noted that the second filter 30 is, as in the case of the first filter 20, provided with a drive terminal (not illustrated) electrically coupled to each of the third electrode 351 and the fourth electrode 352 of the second actuator 35 and a detection terminal (not illustrated) electrically coupled to each of the third detection electrode 361 and the fourth detection electrode 362. These terminals are coupled to the controller 50, and a drive voltage is applied to the second actuator 35 and the dimension of the second gap G2 is detected using the second capacitance detector 36 under the control of the controller 50.

It should be noted that the first fixed substrate 22 and the second fixed substrate 32 are disposed with a gap in the example illustrated in FIG. 1, this is to distinguish the first filter 20 and the second filter 30 from each other, and yet the fourth surface 22B of the first fixed substrate 22 and the eighth surface 32B of the second fixed substrate 32 may be joined by a light-transmitting joining member.

In addition, the first fixed substrate 22 and the second fixed substrate 32 may have the same configuration. In other words, the first fixed substrate 22 and the second fixed substrate 32 may be configured by one substrate, the mirror base 221 and the groove portion 222 may be provided on the surface of the substrate that faces the first movable substrate 21, and the second mirror base 321 and the second groove portion 322 may be provided on the surface of the substrate that faces the second movable substrate 31.

In addition, the disposition of the first filter 20 and the second filter 30 is not limited to the present embodiment in which light is incident from the first surface 21A of the first movable substrate 21, the light transmitted through the first filter 20 is incident from the fourth surface 22B of the first fixed substrate 22 to the eighth surface 32B of the second fixed substrate 32, and the light transmitted through the second filter 30 is directed from the fifth surface 31A of the second movable substrate 31 toward the light receiver 40 as illustrated in FIG. 1. For example, light may be incident from the fourth surface 22B of the first filter 20 and the light transmitted through the first filter 20 may be incident on the second filter 30 from the first surface 21A of the first movable substrate 21. In addition, also in the second filter 30, the light from the first filter 20 may be incident from the fifth surface 31A and the light transmitted through the second filter 30 may be directed from the eighth surface 32B toward the light receiver 40.

### Configuration of Second Movable Reflective Film 33 and Second Fixed Reflective Film 34

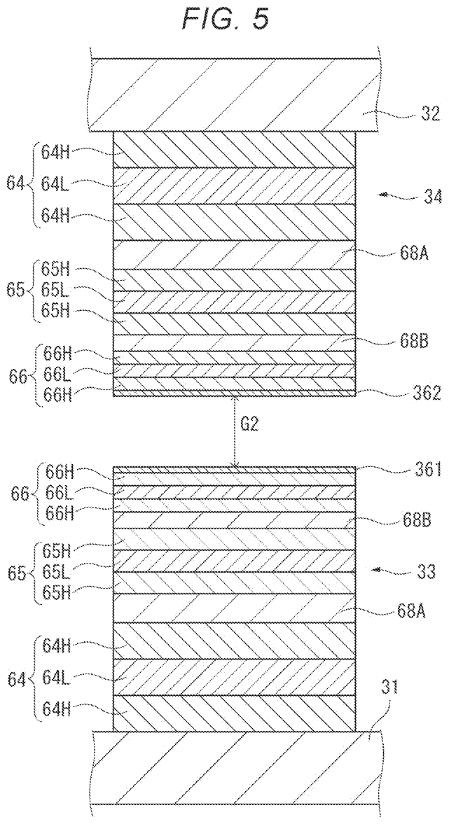

FIG. 5 is a diagram illustrating a schematic configuration of the second movable reflective film 33 and the second fixed reflective film 34 in the second filter 30 of the first embodiment.

As described above, the second movable reflective film 33 and the second fixed reflective film 34 are substantially identical in configuration to the first movable reflective film 23 and the first fixed reflective film 24.

In other words, the second movable reflective film 33 is configured by a plurality of laminated bodies (optical bodies) being laminated from the second movable substrate 31 toward the second gap G2. In addition, the second fixed reflective film 34 is configured by a plurality of laminated bodies (optical bodies) being laminated from the second fixed substrate 32 toward the second gap G2.

In the example illustrated in FIG. 5, a fourth laminated body 64, a fifth laminated body 65, and a sixth laminated body 66 are provided as the plurality of laminated bodies. The fourth laminated body 64 is laminated on the second movable substrate 31 or the second fixed substrate 32. The sixth laminated body 66 is disposed at the position that is closest to the second gap G2 in the second movable reflective film 33 and the second fixed reflective film 34. The fifth laminated body 65 is disposed between the fourth laminated body 64 and the sixth laminated body 66.

It should be noted that an example in which the second movable reflective film 33 and the second fixed reflective film 34 are configured to include three laminated bodies as described above is illustrated in the example of FIG. 5 and yet a configuration including four or more laminated bodies, a configuration including two laminated bodies, and so on may be used instead.

Each of the laminated bodies is configured by high-refractive and low-refractive layers being alternately laminated as in the case of the first movable reflective film 23 and the first fixed reflective film 24. For example, in the fourth laminated body 64, a fourth high-refractive layer 64H, a fourth low-refractive layer 64L, and the fourth high-refractive layer 64H are alternately laminated in this order from the second movable substrate 31 or the second fixed substrate 32. A fifth high-refractive layer 65H, a fifth low-refractive layer 65L, and the fifth high-refractive layer 65H are alternately laminated in this order from the fourth laminated body 64 side in the fifth laminated body 65, and a sixth high-refractive layer 66H, a sixth low-refractive layer 66L, and the sixth high-refractive layer 66H are alternately laminated in this order from the fifth laminated body 65 side in the sixth laminated body 66.

In the following description, the refractive index of the fourth high-refractive layer 64H is n_{4H}, the thickness of the fourth high-refractive layer 64H is d_{4H}, the refractive index of the fourth low-refractive layer 64L is n_{4L}, and the thickness of the fourth low-refractive layer 64L is d_{4L}. The refractive index of the fifth high-refractive layer 65H is n_{5H}, the thickness of the fifth high-refractive layer 65H is d_{5H}, the refractive index of the fifth low-refractive layer 65L is n_{5L}, and the thickness of the fifth low-refractive layer 65L is d_{5L}. The refractive index of the sixth high-refractive layer 66H is n_{6H}, the thickness of the sixth high-refractive layer 66H is d_{6H}, the refractive index of the sixth low-refractive layer 66L is n_{6L}, and the thickness of the sixth low-refractive layer 66L is d_{6L}.

Here, the fourth laminated body 64 is a dielectric multilayer film that reflects light centered on a fourth design center wavelength λ₄. In other words, in the fourth laminated body 64, the fourth high-refractive layer 64H and the fourth low-refractive layer 64L have the same optical film thickness (fourth optical film thickness). Specifically, the fourth optical film thickness of the fourth high-refractive layer 64H and the fourth low-refractive layer 64L satisfies n_{4H}×d_{4H}=n_{4L}×d_{4L}=λ₄/4. Here, the fourth design center wavelength λ₄ is different from the first design center wavelength λ₁, the second design center wavelength λ₂, and the third design center wavelength λ₃ (λ₄≠λ₁, λ₄≠λ₂, λ₄≠λ₃).

The fifth laminated body 65 is a dielectric multilayer film that reflects light centered on a fifth design center wavelength λ₅. In other words, in the fifth laminated body 65, the fifth high-refractive layer 65H and the fifth low-refractive layer 65L have the same optical film thickness (fifth optical film thickness). Specifically, the fifth optical film thickness of the fifth high-refractive layer 65H and the fifth low-refractive layer 65L satisfies n_{5H}×d_{5H}=n_{5L}×d_{5L}=λ₅/4. Here, the fifth design center wavelength λ₅ satisfies the relationship of λ₅≠λ₁, λ₅≠λ₂, λ₅≠λ₃ and A4>λ₅.

Likewise, the sixth laminated body 66 is a dielectric multilayer film that reflects light centered on a sixth design center wavelength λ₆. In other words, in the sixth laminated body 66, the sixth high-refractive layer 66H and the sixth low-refractive layer 66L have the same optical film thickness (sixth optical film thickness). Specifically, the sixth optical film thickness of the sixth high-refractive layer 66H and the sixth low-refractive layer 66L satisfies n_{6H}×d_{6H}=n_{6L}×d_{6L}=λ₆/4. Here, the sixth design center wavelength λ₆ satisfies the relationship of λ₆≠λ₁, λ₆≠λ₂, λ₆≠λ₃ and λ₄>λ₅>λ₆.

The fourth design center wavelength λ₄, the fifth design center wavelength λ₅, and the sixth design center wavelength λ₆ are set in accordance with the wavelength range to be measured by the spectroscopic measuring device 1 (hereinafter, referred to as the measurement wavelength range) as in the case of the first design center wavelength λ₁, the second design center wavelength λ₂, and the third design center wavelength λ₃. For example, λ₄ is set to 850 nm, λ₅ is set to 500 nm, and λ₆ is set to 350 nm as an example of a case where the object wavelength range (400 nm to 1,000 nm) is from the visible light range to the near infrared wide range.

It should be noted that an example in which the wavelength interval between the fourth design center wavelength λ₄ and the fifth design center wavelength λ₅ is larger than the wavelength interval between the fifth design center wavelength λ₅ and the sixth design center wavelength λ₆ is illustrated and yet the present disclosure is not limited thereto. For example, the wavelength interval between the fifth design center wavelength λ₅ and the sixth design center wavelength λ₆ and the wavelength interval between the fifth design center wavelength λ₅ and the sixth design center wavelength λ₆ may be equal to each other.

In addition, when the wavelength interval between the first design center wavelength λ₁ and the second design center wavelength λ₂ is larger than the wavelength interval between the second design center wavelength λ₂ and the third design center wavelength λ₃ in the first filter 20, the wavelength interval between the fourth design center wavelength λ₄ and the fifth design center wavelength λ₅ may be set to be smaller than the wavelength interval between the fifth design center wavelength λ₅ and the sixth design center wavelength λ₆ in the second filter 30. Alternatively, when the wavelength interval between the first design center wavelength λ₁ and the second design center wavelength λ₂ is smaller than the wavelength interval between the second design center wavelength λ₂ and the third design center wavelength λ₃ in the first filter 20, the wavelength interval between the fourth design center wavelength λ₄ and the fifth design center wavelength λ₅ may be set to be larger than the wavelength interval between the fifth design center wavelength λ₅ and the sixth design center wavelength λ₆ in the second filter 30.

In addition, the fourth laminated body 64 and the fifth laminated body 65 are connected via a light-transmitting third connecting layer 68A and the fifth laminated body 65 and the sixth laminated body 66 are connected via a light-transmitting fourth connecting layer 68B.

The third connecting layer 68A has a refractive index n₈ₐ and a film thickness d₈ₐ, and the optical film thickness of the third connecting layer 68A is an optical film thickness based on the average of the fourth design center wavelength λ₄ and the fifth design center wavelength λ₅. In other words, assuming that the design center wavelength of the third connecting layer 68A is λ₈ₐ, the design center wavelength λ₈ₐ a is λ₈ₐ=(λ₄+λ₅)/2 and satisfies n₈ₐ×d₈ₐ=λ₈ₐ/4.

The fourth connecting layer 68B has a refractive index n₈ₐ and a film thickness d_{8b}, and the optical film thickness of the fourth connecting layer 68B is an optical film thickness based on the average of the fifth design center wavelength λ₅ and the sixth design center wavelength λ₆. In other words, assuming that the design center wavelength of the fourth connecting layer 68B is λ_{8b}, the design center wavelength λ_{8b} is λ_{8b}=(λ₅+λ₆)/2 and satisfies n_{8b}×d_{8b}=λ_{8b}/4.

To further describe the present embodiment with a specific example, the fourth high-refractive layer 64H, the fifth high-refractive layer 65H, and the sixth high-refractive layer 66H are made of the same material in the second movable reflective film 33 and the second fixed reflective film 34. In addition, the fourth low-refractive layer 64L, the fifth low-refractive layer 65L, and the sixth low-refractive layer 66L are made of the same material.

In addition, in the present embodiment, the layer of the fourth laminated body 64 that is disposed closest to the fifth laminated body 65 side is the fourth high-refractive layer 64H and the layer of the fifth laminated body 65 that is disposed closest to the fourth laminated body 64 side is the fifth high-refractive layer 65H. Likewise, the layer of the fifth laminated body 65 that is disposed closest to the sixth laminated body 66 side is the fifth high-refractive layer 65H and the layer of the sixth laminated body 66 that is disposed closest to the fifth laminated body 65 side is the sixth high-refractive layer 66H. In this case, it is preferable to use low-refractive layers as the third connecting layer 68A and the fourth connecting layer 68B and, for example, the same material as the fourth low-refractive layer 64L, the fifth low-refractive layer 65L, and the sixth low-refractive layer 66L can be used.

In this case, n_{4H}×n_{5H}=n_{6H} and n_{4L}=n_{5L}=n_{6L}=n₈ₐ=n_{8b} are satisfied, and thus the optical film thickness of each of the laminated bodies 64, 65, and 66 and the connecting layers 68A and 68B can be set simply with the thickness of each layer.

It should be noted that the optical film thickness of the third detection electrode 361 provided on the second movable reflective film 33 and the optical film thickness of the fourth detection electrode 362 provided on the second fixed reflective film 34 are sufficiently smaller than the optical film thickness of each layer constituting each of the laminated bodies 64, 65, and 66. For example, in the present embodiment, the third detection electrode 361 and the fourth detection electrode 362 are configured by IGO and are formed so as to, for example, have a film thickness of approximately 10 nm at an optical film thickness of 20 nm.

### Configuration of Light Receiver 40

The light receiver 40 is a sensor that receives light transmitted through the optical filter 10. An image sensor (e.g. CCD or CMOS) can be used as the light receiver 40. When the light receiver 40 receives the light transmitted through the optical filter 10, the light receiver 40 outputs a light receiving signal corresponding to the amount of received light to the controller 50.

### Configuration of Controller 50

As illustrated in FIG. 1, the controller 50 is configured to include a filter drive circuit 51, a light receiving control circuit 52, a spectroscopic measurer 53, and so on.

The filter drive circuit 51 controls the drive of the optical filter 10. The filter drive circuit 51 may be provided on a circuit substrate where the optical filter 10 is installed or may be provided separately from the circuit substrate.

The filter drive circuit 51 includes a first drive circuit 511, a second drive circuit 512, a first capacitance detection circuit 513, a second capacitance detection circuit 514, a memory 515, and a microcomputer 516.

The first drive circuit 511 applies a first drive voltage to the first actuator 25 of the first filter 20 based on the control of the microcomputer 516.

The second drive circuit 512 applies a second drive voltage to the second actuator 35 of the second filter 30 based on the control of the microcomputer 516.

The first capacitance detection circuit 513 receives a detection signal corresponding to the electric charge held by the first capacitance detector 26 of the first filter 20. The detection signal changes in accordance with the dimension of the first gap G1. The first capacitance detection circuit 513 outputs the detection signal to the first drive circuit 511.

As in the case of the first capacitance detection circuit 513, the second capacitance detection circuit 514 receives a detection signal corresponding to the electric charge held by the second capacitance detector 36 of the second filter 30 and outputs the detection signal to the second drive circuit 512.

Then, the first drive circuit 511 feedback-controls the voltage that is applied to the first actuator 25 in accordance with the dimension of the first gap G1 detected by the first capacitance detection circuit 513. Likewise, the second drive circuit 512 feedback-controls the voltage that is applied to the second actuator 35 in accordance with the dimension of the second gap G2 detected by the second capacitance detection circuit 514.

It should be noted that the wavelength of the light transmitted through the first filter 20 and the second filter 30, the wavelength of the light transmitted through the optical filter 10, and a method for controlling the optical filter 10 will be described later.

A drive table is recorded in the memory 515, and recorded in the drive table are a target wavelength of light transmitted from the optical filter 10, a target value (first target value) of the first gap G1 corresponding to the target wavelength, and a target value (second target value) of the second gap G2 corresponding to the target wavelength. In addition, an initial drive voltage corresponding to each target value may be recorded in the memory 515.

When the microcomputer 516 receives a measurement initiation command from the spectroscopic measurer 53, the microcomputer 516 sets the target wavelength and controls the first drive circuit 511 and the second drive circuit 512 to perform spectroscopic measurement. The measurement initiation command from the spectroscopic measurer 53 includes, for example, a command to the effect of performing spectroscopic measurement for each wavelength in a predetermined wavelength range at a predetermined wavelength interval and a measurement command for a single target wavelength.

The light receiving control circuit 52 includes a sampling circuit sampling the light receiving signal output from the light receiver 40, an amplifier circuit amplifying the light receiving signal, an A/D conversion circuit converting the light receiving signal into a digital signal, and so on. The light receiving control circuit 52 processes the light receiving signal using the circuits and inputs the light receiving signal to the spectroscopic measurer 53 after the signal processing.

The spectroscopic measurer 53 commands the filter drive circuit 51 and the light receiving control circuit 52 to initiate spectroscopic measurement based on, for example, user operation. Then, spectroscopic measurement is performed on the measurement object based on the light receiving signal input from the light receiving control circuit 52.

It should be noted that the present embodiment exemplifies a configuration in which the controller 50 includes the spectroscopic measurer 53 and yet the spectroscopic measurer 53 may be, for example, provided separately from the spectroscopic measuring device 1. In this case, for example, a computer such as a personal computer and a tablet terminal coupled so as to be capable of communicating with the spectroscopic measuring device 1 is capable of functioning as the spectroscopic measurer 53.

### Spectroscopic Measurement Method Using Spectroscopic Measuring Device 1

Next, a spectroscopic measurement method using the spectroscopic measuring device 1 of the present embodiment and the optical characteristics of the first filter 20 and the second filter 30 of the optical filter 10 will be described.

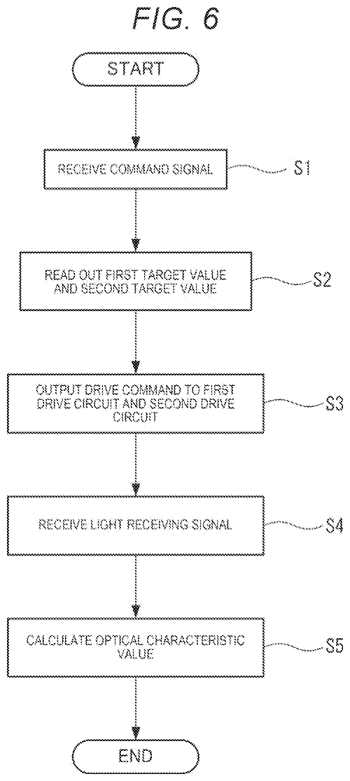

FIG. 6 is a flowchart showing the spectroscopic measurement method in the spectroscopic measuring device 1 of the present embodiment.

In the spectroscopic measuring device 1 of the present embodiment, an operation signal to the effect of performing spectroscopic measurement processing is input to the spectroscopic measurer 53 by, for example, a user and then a spectroscopic measurement command signal is output from the spectroscopic measurer 53 to the filter drive circuit 51 and the light receiving control circuit 52.

Here, a case where a command signal to the effect of performing spectroscopic measurement processing with one specific wavelength as a target wavelength is output will be exemplified as an example.

When the microcomputer 516 receives the command signal from the spectroscopic measurer 53 in the filter drive circuit 51 (Step S1), the microcomputer 516 reads out the first and second target values corresponding to the target wavelength from the drive data of the memory 515 (Step S2).

Then, the microcomputer 516 outputs a drive command for drive based on the first target value to the first drive circuit 511 and outputs a drive command for drive based on the second target value to the second drive circuit 512 (Step S3).

As a result, the first drive circuit 511 controls the first actuator 25 such that the first gap G1 input from the first capacitance detection circuit 513 has a dimension corresponding to the first target value. In addition, the second drive circuit 512 controls the second actuator 35 such that the second gap G2 input from the second capacitance detection circuit 514 has a dimension corresponding to the second target value.

Here, the optical characteristics of the optical filter 10 of the present embodiment will be described.

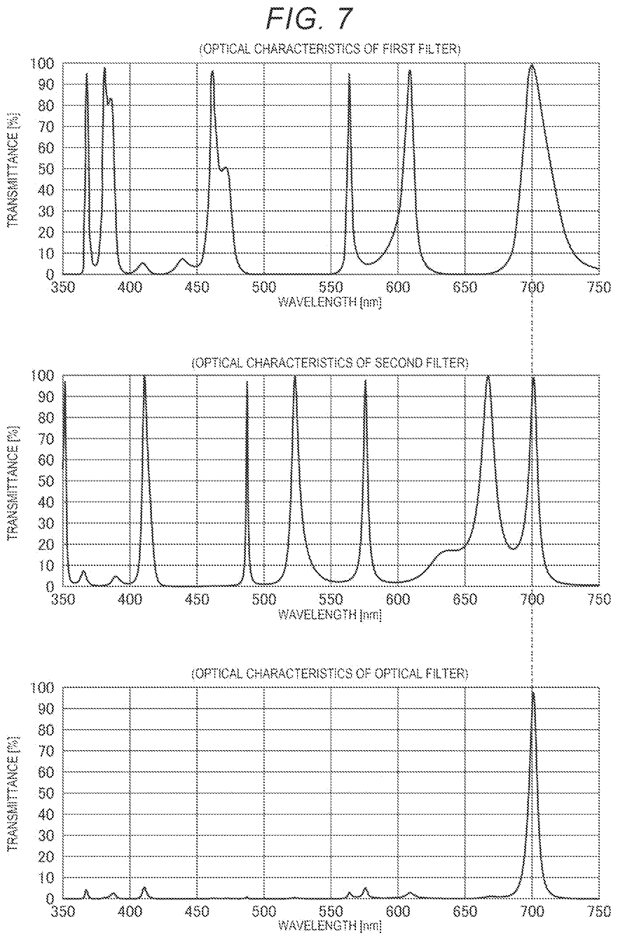

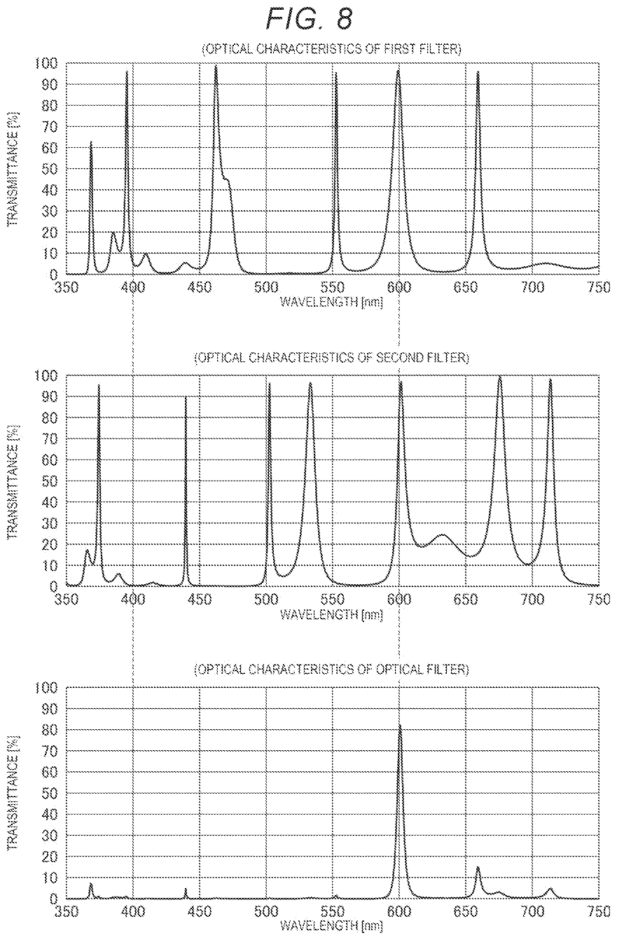

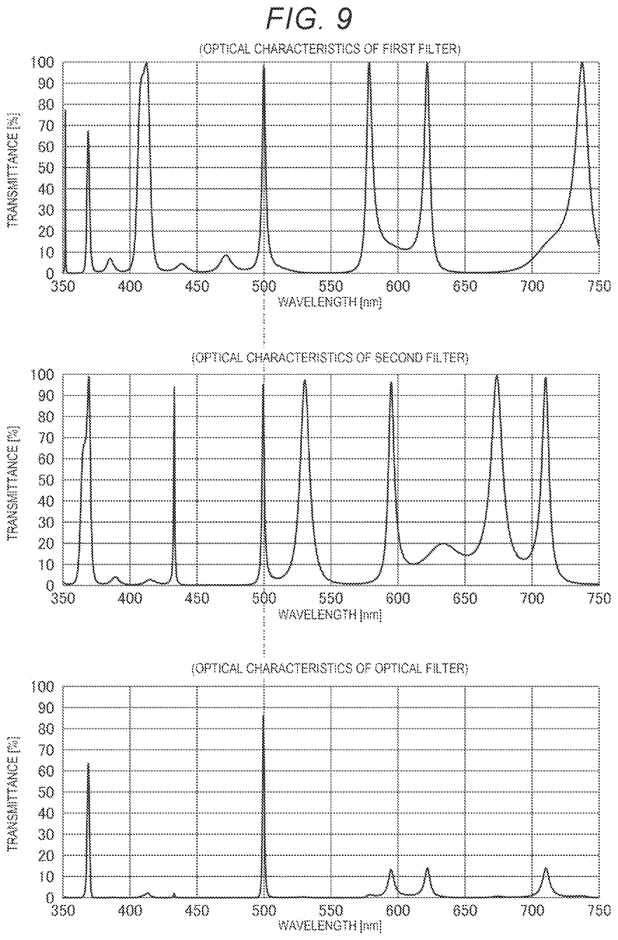

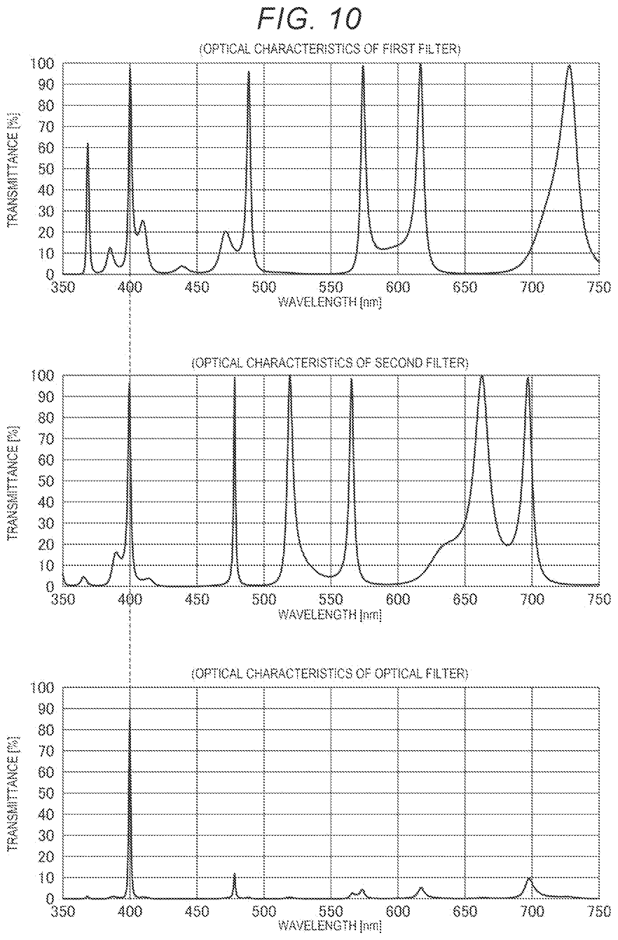

FIGS. 7 to 10 are diagrams illustrating the spectral characteristics of the first filter 20, the spectral characteristics of the second filter 30, and the transmission characteristics of light transmitted through the optical filter 10 in the present embodiment. FIG. 7 is a diagram in which the first gap G1 and the second gap G2 are controlled such that 700 nm light is transmitted from the optical filter 10. FIG. 8 is a diagram in which the first gap G1 and the second gap G2 are controlled such that 600 nm light is transmitted from the optical filter 10. FIG. 9 is a diagram in which the first gap G1 and the second gap G2 are controlled such that 500 nm light is transmitted from the optical filter 10. FIG. 10 is a diagram in which the first gap G1 and the second gap G2 are controlled such that 400 nm light is transmitted from the optical filter 10.

The first filter 20 of the present embodiment has the first movable reflective film 23 and the first fixed reflective film 24 configured by the first laminated body 61, the second laminated body 62, and the third laminated body 63 being sequentially laminated. The first filter 20 is wider in measurement wavelength range than a normal tunable interference filter using a dielectric multilayer film in which the layer thicknesses of high-refractive and low-refractive layers are designed based on one design center wavelength. In other words, the measurement wavelength range is a narrow band of approximately 100 nm to 200 nm in the normal tunable interference filter using the dielectric multilayer film and spectral characteristics cannot be obtained and light is transmitted with high transmittance outside the band. In contrast, the first filter 20 of the present embodiment has spectral characteristics in a wide measurement wavelength range of approximately 600 nm from the visible light range to the near infrared range as illustrated in FIGS. 7 to 10.

Likewise, the second filter 30 has the second movable reflective film 33 and the second fixed reflective film 34 configured by the fourth laminated body 64, the fifth laminated body 65, and the sixth laminated body 66 being sequentially laminated. As a result, as in the case of the first filter 20, the second filter 30 has spectral characteristics in a wide measurement wavelength range of approximately 600 nm from the visible light range to the near infrared range.

In addition, each of the first filter 20 and the second filter 30 includes a plurality of peak wavelengths in which the light transmittance is at least a predetermined value (for example, at least 50%) in the measurement wavelength range. The half-value width of the transmitted light at each peak wavelength is narrower than that of a Fabry-Perot etalon using a metal film or a metal alloy film as a reflective film, and it is possible to output a wavelength centered on the peak wavelength with high wavelength resolution. The peak wavelengths are shifted to the short wavelength side as a whole when the dimensions of the gaps G1 and G2 are reduced and shifted to the long wavelength side as a whole when the dimensions of the gaps G1 and G2 are increased.

In the present embodiment, the first gap G1 and the second gap G2 are set such that one of the plurality of peak wavelengths transmitted through the first filter 20 (first peak wavelength) and one of the plurality of peak wavelengths transmitted through the second filter 30 (second peak wavelength) are target wavelengths. Here, the design center wavelengths of the first laminated body 61, the second laminated body 62, and the third laminated body 63 of the first filter 20 are different from the design center wavelengths of the fourth laminated body 64, the fifth laminated body 65, and the sixth laminated body 66 of the second filter 30. Accordingly, the wavelength interval of each peak wavelength in the first filter 20 and the wavelength interval of each peak wavelength of the second filter 30 are different from each other. Accordingly, when the first peak wavelength of the first filter 20 is set as a target wavelength and the second peak wavelength of the second filter 30 is set as a target wavelength, the other peak wavelengths do not overlap.

For example, in the example illustrated in FIG. 7, the first gap G1 is controlled such that a target wavelength of 700 nm is reached with the first peak wavelength from the long wavelength side serving as the first peak wavelength in the first filter 20 and the second gap G2 is controlled such that a target wavelength of 700 nm is reached with the first peak wavelength from the long wavelength side serving as the second peak wavelength in the second filter 30. As illustrated in FIG. 7, in this case, the peak wavelengths other than 700 nm are different wavelengths in the first filter 20 and the second filter 30 and light having a peak wavelength of 700 nm and transmitted through the first filter 20 and the second filter 30 is transmitted through the optical filter 10.

The same applies to the other wavelengths and, when 600 nm light is transmitted from the optical filter 10, the second peak wavelength from the long wavelength side serves as the first peak wavelength in the first filter 20, the third peak wavelength from the long wavelength side serves as the second peak wavelength in the second filter 30, and control is performed such that a target wavelength of 600 nm is reached in each as illustrated in, for example, FIG. 8. In a case where 500 nm light is transmitted from the optical filter 10, the fourth peak wavelength from the long wavelength side serves as the first peak wavelength in the first filter 20, the fifth peak wavelength from the long wavelength side serves as the second peak wavelength in the second filter 30, and control is performed such that a target wavelength of 500 nm is reached in each as illustrated in, for example, FIG. 9. In a case where 400 nm light is transmitted from the optical filter 10, the fifth peak wavelength from the long wavelength side serves as the first peak wavelength in the first filter 20, the sixth peak wavelength from the long wavelength side serves as the second peak wavelength in the second filter 30, and control is performed such that a target wavelength of 400 nm is reached in each as illustrated in, for example, FIG. 10.

In other words, each target wavelength, the first target value for controlling the first actuator 25 with respect to the target wavelength, and the second target value for controlling the second actuator 35 with respect to the target wavelength are recorded in the memory 515. At the first and second target values, the peak wavelength other than the first peak wavelength transmitted through the first filter 20 and the peak wavelength other than the second peak wavelength transmitted through the second filter 30 are different from each other when the first and second peak wavelengths are target wavelengths. Further, the microcomputer 516 reads out the first target value and the second target value with respect to the target wavelength and outputs the values to the first drive circuit 511 and the second drive circuit 512, and then light having a target wavelength can be transmitted from the optical filter 10 as illustrated in FIGS. 7 to 10.

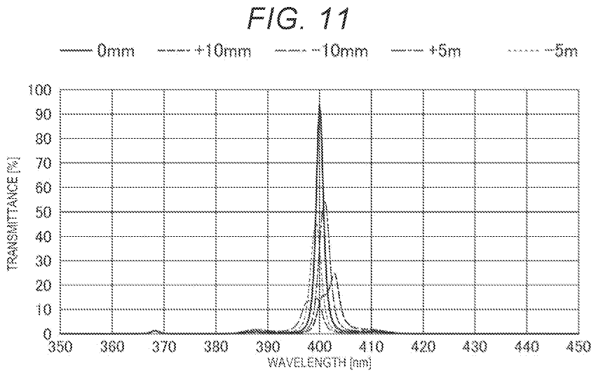

FIG. 11 is a diagram illustrating the relationship between the difference between the first peak wavelength and the second peak wavelength and the light transmitted through the optical filter 10 with the target wavelength.

The example of FIG. 11, in which the target wavelength is 400 nm, illustrates the transmittance of light transmitted through the optical filter 10 when the first peak wavelength is 400 nm and the second peak wavelength is shifted from 400 nm.

As illustrated in FIG. 11, when the absolute value of the difference between the first peak wavelength and the second peak wavelength exceeds 10 nm, the transmittance of the light transmitted through the optical filter 10 is less than 10%, which leads to a decline in the measurement accuracy of the spectroscopic measuring device 1 for the light having the target wavelength.

In contrast, it is possible to transmit the light having the target wavelength from the optical filter 10 with a transmittance of 10% or more when the absolute value of the difference between the first peak wavelength and the second peak wavelength is 10 nm or less. In other words, in Step S3, it is preferable that the first drive circuit 511 and the second drive circuit 512 control the first actuator 25 of the first filter 20 and the second actuator 35 of the second filter 30 such that the first peak wavelength and the second peak wavelength are included in the target wavelength range of target wavelength ±5 nm.

More preferably, the first drive circuit 511 and the second drive circuit 512 control the first actuator 25 and the second actuator 35 such that the absolute value of the difference between the first peak wavelength and the second peak wavelength is 5 nm or less. As illustrated in FIG. 11, in this case, it is possible to transmit the light having the target wavelength with a transmittance of 30% or more.

Accordingly, in the present embodiment, the first drive circuit 511 and the second drive circuit 512 perform feedback control such that the first gap G1 and the second gap G2 have dimensions corresponding to the target wavelength as described above and the absolute value of the difference between the first peak wavelength based on the first gap G1 and the second peak wavelength based on the second gap G2 is 10 nm or less, more preferably, 5 nm or less. At this time, the first drive circuit 511 may refer to the detection signal from the second capacitance detection circuit 514 in addition to the detection signal of the first capacitance detection circuit 513 and the second drive circuit 512 may refer to the detection signal from the first capacitance detection circuit 513 in addition to the detection signal of the second capacitance detection circuit 514. In addition, the first drive circuit 511 and the second drive circuit 512 may refer to the detection signals of the first capacitance detection circuit 513 and the second capacitance detection circuit 514, respectively.

Returning to FIG. 6, after Step S3, the spectroscopic measurer 53 receives the light receiving signal output from the light receiving control circuit 52 (Step S4) and calculates an optical characteristic value with respect to the target wavelength to be measured based on the signal value of the received signal (Step S5). For example, the spectroscopic measurer 53 calculates the amount of light, reflectance, and so on with respect to the target wavelength to be measured. It should be noted that only spectroscopic measurement for one wavelength is exemplified in the present embodiment and yet Steps S1 to S5 may also be repeated in the case of, for example, calculating the spectral spectrum for each wavelength at a predetermined interval in the measurement wavelength range.

### Action and Effect of Present Embodiment

The optical filter 10 of the present embodiment includes the first filter 20 and the second filter 30. The first filter 20 includes the first movable reflective film 23 and the first fixed reflective film 24 facing each other via the first gap G1 and the first actuator 25 changing the gap between the first movable reflective film 23 and the first fixed reflective film 24. The second filter 30 includes the second movable reflective film 33 and the second fixed reflective film 34 facing each other via the second gap G2 and the second actuator 35 changing the gap between the second movable reflective film 33 and the second fixed reflective film 34 and is disposed on the optical path of the light transmitted through the first filter 20. Further, each of the first movable reflective film 23, the first fixed reflective film 24, the second movable reflective film 33, and the second fixed reflective film 34 is configured by a plurality of laminated bodies (optical bodies) being laminated, each laminated body has reflection characteristics of reflecting light centered on a predetermined design center wavelength, and the design center wavelengths are different in the laminated bodies.

In the first filter 20, light having a plurality of peak wavelengths corresponding to the dimension of the first gap G1 can be transmitted and the peak wavelength appears in a wide measurement wavelength range from the visible light range to the near infrared range. As in the case of the first filter 20, in the second filter 30, light having a plurality of peak wavelengths corresponding to the dimension of the second gap G2 can be transmitted and the peak wavelength appears in a wide measurement wavelength range from the visible light range to the near infrared range. In addition, the design center wavelength of each laminated body constituting the second movable reflective film 33 and the second fixed reflective film 34 is different from the design center wavelength of each laminated body constituting the first movable reflective film 23 and the first fixed reflective film 24, and thus each peak wavelength is different from each peak wavelength of the first filter 20 even when the second gap G2 has the same dimension as the first gap G1.

In the optical filter 10 of the present embodiment, the first gap G1 is adjusted such that one of the plurality of peak wavelengths of the first filter 20 becomes the target wavelength and the second gap G2 is adjusted such that one of the plurality of peak wavelengths of the second filter 30 becomes the target wavelength. As a result, the peak wavelengths other than the target wavelengths in the first filter 20 and the second filter 30 do not overlap and the light of these peak wavelengths is not transmitted through the optical filter 10. In other words, only the light centered on the target wavelength is transmitted from the optical filter 10.

In addition, in the spectral characteristics of the first filter 20 and the second filter 30 of the present embodiment, the half-value width at each peak wavelength is sufficiently smaller than that of a Fabry-Perot etalon using a metal film as a reflective film and the wavelength resolution is very high. Accordingly, light of the target wavelength can be transmitted from the optical filter 10 with high resolution.

As described above, the optical filter 10 of the present embodiment is capable of dispersing and transmitting light having a desired target wavelength from a wide measurement wavelength range with high accuracy.

In the present embodiment, each optical body constituting the first movable reflective film 23, the first fixed reflective film 24, the second movable reflective film 33, and the second fixed reflective film 34 is a laminated body in which high-refractive and low-refractive layers are alternately laminated and each of the optical film thickness of the high-refractive layer and the optical film thickness of the low-refractive layer is a film thickness based on the design center wavelength set for each laminated body.

As a result, it is possible to configure the first filter 20 and the second filter 30 having spectral characteristics in which a plurality of peak wavelengths appear evenly with respect to a wide measurement wavelength range as illustrated in FIGS. 7 to 10.

In the present embodiment, each of the first movable reflective film 23, the first fixed reflective film 24, the second movable reflective film 33, and the second fixed reflective film 34 further includes a connecting layer connecting a pair of laminated bodies adjacent to each other. For example, the first laminated body 61 and the second laminated body 62 are connected by the first connecting layer 67A and the first connecting layer 67A has an optical film thickness set based on the average of the first design center wavelength λ₁ of the first laminated body 61 and the second design center wavelength λ₂ of the second laminated body 62.

As a result, the difference in design center wavelength between the laminated bodies can be leveled by the connecting layer and it is possible to obtain spectral characteristics in which a plurality of peak wavelengths are substantially even.

In the present embodiment, the design center wavelength of each laminated body constituting the first movable reflective film 23 and the first fixed reflective film 24 of the first filter 20 is different from the design center wavelength of each laminated body constituting the second movable reflective film 33 and the second fixed reflective film 34 of the second filter 30.

As a result, the peak wavelength of the light transmitted through the first filter 20 and the peak wavelength of the light transmitted through the second filter 30 are different from each other. Accordingly, when the first gap G1 and the second gap G2 are changed such that one of the plurality of peak wavelengths of the first filter 20 and one of the plurality of peak wavelengths of the second filter 30 become the target wavelengths, the peak wavelengths other than the light of the target wavelength are not transmitted and only the light in a narrow band centered on the target wavelength can be transmitted.

In the present embodiment, the design center wavelengths λ₁, λ₂, and λ₃ of the laminated bodies 61, 62, and 63 constituting the first movable reflective film 23 and the first fixed reflective film 24 become shorter as the first gap G1 is approached. The design center wavelengths λ₄, As, and λ₆ of the laminated bodies 64, 65, and 66 constituting the second movable reflective film 33 and the second fixed reflective film 34 become shorter as the second gap G2 is approached.

As a result, the peak wavelength of the light transmitted through the first filter 20 appears substantially uniform in the measurement wavelength range and the peak wavelength of the light transmitted through the second filter 30 appears substantially uniform in the measurement wavelength range.

In other words, when a tunable interference filter in which laminated bodies are laminated such that the design center wavelength becomes longer toward the gap is described as a comparative example, the tunable interference filter of the comparative example has spectral characteristics that the half-value width at the peak wavelength on the long wavelength side increases and the light transmittance increases in the wavelength range between the peak wavelengths adjacent to each other. Accordingly, in such a tunable interference filter, the spectral accuracy on the long wavelength side is deteriorated as compared with the present embodiment.

In addition, in the tunable interference filter of the comparative example, the wavelength interval of the plurality of peak wavelengths increases and wavelengths may be generated that cannot be dispersed even with a change in inter-reflective film gap. It should be noted that it is possible to increase the amount of peak wavelength shift by increasing the variable distance of the gap and yet, in this case, the size of the tunable interference filter increases and the movable portion is likely to be tilted or bent, which deteriorates the spectral accuracy.

Further, in the tunable interference filter of the comparative example, the interval of the plurality of peak wavelengths on the short wavelength side is shorter than that of the present embodiment. Accordingly, a wavelength overlapping the peak wavelength of the second filter 30 may be generated at the peak wavelength other than the target wavelength and light having a plurality of peak wavelengths may be transmitted from the optical filter 10.

In contrast, in the present embodiment, the plurality of peak wavelengths appear substantially uniform in the measurement wavelength range, and thus the above problems are unlikely to arise and the light of the target wavelength can be transmitted from the optical filter 10 with high resolution and high accuracy.

The spectroscopic measuring device 1 of the present embodiment includes the optical filter 10 and the controller 50 that controls the first actuator 25 and the second actuator 35. Further, the controller 50 controls the first actuator 25 such that the first peak wavelength, which is one of the plurality of peak wavelengths transmitted through the first filter 20, is included in the target wavelength range centered on a desired target wavelength. Further, the controller 50 controls the second actuator 35 such that the second peak wavelength, which is one of the plurality of peak wavelengths transmitted through the second filter 30, is included in the target wavelength range and the peak wavelength other than the first peak wavelength transmitted through the first filter 20 and the peak wavelength other than the second peak wavelength transmitted through the second filter 30 are different.

As a result, the light of the target wavelength transmitted through the first filter 20 and the second filter 30 can be transmitted with high wavelength resolution and the target wavelength can be selected in a wide measurement wavelength range from the visible light range to the near infrared range.

Further, in the spectroscopic measuring device 1 of the present embodiment, the controller 50 controls the first actuator 25 and the second actuator 35 such that the difference between the first peak wavelength and the second peak wavelength is 10 nm or less.

In a case where the first peak wavelength and the second peak wavelength are the target wavelengths in the present embodiment, both do not have to exactly match the target wavelength and may be included in at least the target wavelength range, which is a predetermined wavelength range centered on the target wavelength. Since the difference between the first peak wavelength and the second peak wavelength is 10 nm or less at this time, light of the target wavelength can be transmitted from the optical filter 10 with a transmittance of 10% or more and it is possible to set the transmittance to 30% or more by setting the difference between the first peak wavelength and the second peak wavelength to 5 nm or less.

### Second Embodiment

Next, a second embodiment will be described.

In the first embodiment, a laminated body is configured by high-refractive and low-refractive layers being alternately laminated based on the same design center wavelength and the first movable reflective film 23, the first fixed reflective film 24, the second movable reflective film 33, and the second fixed reflective film 34 are configured by a plurality of the laminated bodies with different design center wavelengths being laminated. In contrast, the second embodiment differs from the first embodiment in that a laminated body configured by layers having the same design center wavelength is not provided and the design center wavelengths of the high-refractive and low-refractive layers are different from each other.

It should be noted that what have been described above will be denoted by the same reference numerals in the following description and description thereof will be omitted or simplified.

The difference between the present embodiment and the first embodiment consists in the film configuration of the first movable reflective film 23, the first fixed reflective film 24, the second movable reflective film 33, and the second fixed reflective film 34 as described above, and the present embodiment and the first embodiment are identical to each other as to the basic configuration of the spectroscopic measuring device 1. In other words, the spectroscopic measuring device 1 of the present embodiment includes the optical filter 10 provided with the first filter 20 and the second filter 30, the light receiver 40, and the controller 50 as in the first embodiment and detailed description thereof will be omitted.

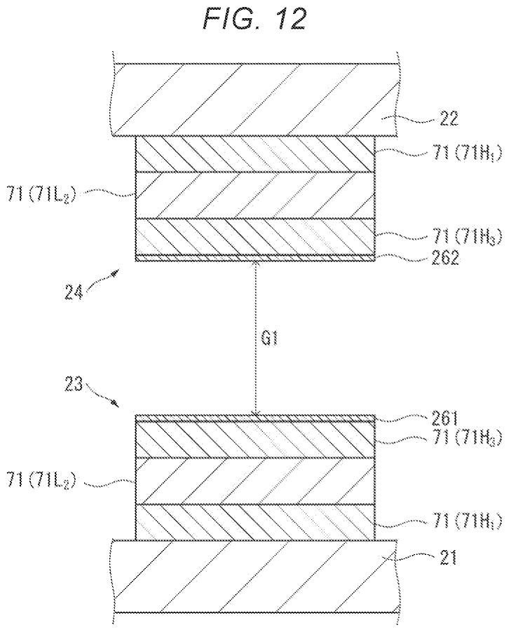

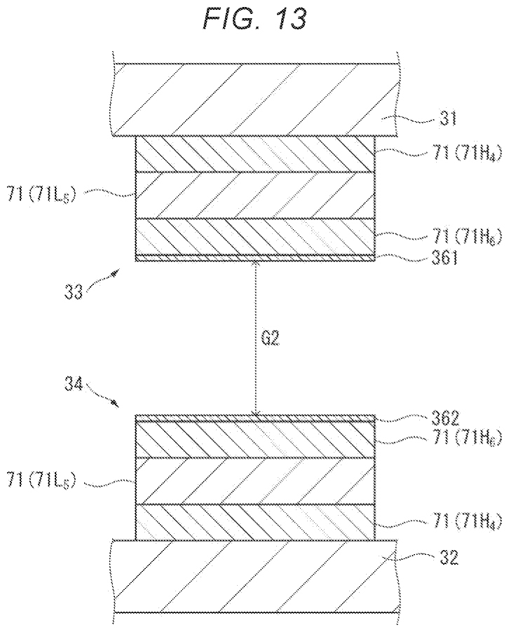

FIG. 12 is a cross-sectional view illustrating the film configuration of the first movable reflective film 23 and the first fixed reflective film 24 of the present embodiment, and FIG. 13 is a cross-sectional view illustrating the film configuration of the second movable reflective film 33 and the second fixed reflective film 34 of the present embodiment.

In the present embodiment, the first movable reflective film 23, the first fixed reflective film 24, the second movable reflective film 33, and the second fixed reflective film 34 are configured by a multilayer film in which a plurality of layers 71 are laminated and each of the layers 71 constitutes the optical body according to the present disclosure. Specifically, each layer 71 includes a high-refractive layer 71H and a low-refractive layer 71L and is configured by the high-refractive layer 71H and low-refractive layer 71L being alternately laminated. For example, a high-refractive layer 71H₁, a low-refractive layer 71L₂, and a high-refractive layer 71H₃ are sequentially laminated on a substrate in the example of FIG. 12 and a high-refractive layer 71H₄, a low-refractive layer 71L₅, and a high-refractive layer 71H₆ are laminated on a substrate in the example of FIG. 13.

It should be noted that FIGS. 12 and 13 illustrate an example in which the first movable reflective film 23, the first fixed reflective film 24, the second movable reflective film 33, and the second fixed reflective film 34 are configured by a three-layer dielectric multilayer film, this is to simplify the description, and yet each may be configured by more layers being laminated. In addition, although an example in which a high-refractive layer, a low-refractive layer, and a high-refractive layer are laminated on a substrate in this order in each layer 71 is illustrated, this may be replaced with a configuration in which, for example, a low-refractive layer, a high-refractive layer, and a low-refractive layer are laminated in this order.

In addition, each layer 71 has an optical film thickness based on a different design center wavelength and the optical film thickness decreases toward the first gap G1 or the second gap G2.

For example, in the present embodiment, the first design center wavelength λ₁ is 950 nm, the second design center wavelength λ₂ is 600 nm, the third design center wavelength λ₃ is 400 nm, the fourth design center wavelength λ₄ is 850 nm, the fifth design center wavelength λ₅ is 500 nm, and the sixth design center wavelength λ₆ is 350 nm.

A layer thickness d_{H1} of the high-refractive layer 71H₁ of the first movable reflective film 23 and the first fixed reflective film 24, a layer thickness d_{L2} of the low-refractive layer 71L₂, and a layer thickness d_{H3} of the high-refractive layer 71H₃ satisfy n_{H}×d_{H1}=λ₁/4, n_{L}×d_{L2}=λ₂/4, and n_{H}×d_{H3}=λ₃/4 when the refractive index of the high-refractive layers 71H₁ and 71H₃ is n_{H} and the refractive index of the low-refractive layer 71L₂ is n_{L}.

A layer thickness d_{H4} of the high-refractive layer 71H₄ of the second movable reflective film 33 and the second fixed reflective film 34, a layer thickness d_{L5} of the low-refractive layer 71L₅, and a layer thickness d_{L6} of the high-refractive layer 71H₆ satisfy n_{H}×d_{H4}=λ₄/4, n_{L}×d_{L5}=λ₅/4, and n_{H}×d_{H6}=λ₆/4.

Also in the optical filter 10 of the second embodiment, the first filter 20 and the second filter 30 exhibit the spectral characteristics illustrated in FIGS. 7 to 10 and a plurality of peak wavelengths appear with respect to a wide measurement wavelength range. Accordingly, as in the first embodiment, only the light of the target wavelength can be transmitted from the optical filter 10 and from the wide measurement wavelength range from the visible light range to the near infrared range by the first filter 20 and the second filter 30 being combined with each other.

### Action and Effect of Present Embodiment

As in the case of the first embodiment, the first filter 20 of the present embodiment has the first movable reflective film 23 and the first fixed reflective film 24 facing each other via the first gap G1 and the first actuator 25 changing the dimension of the first gap G1. Further, the first movable reflective film 23, the first fixed reflective film 24, the second movable reflective film 33, and the second fixed reflective film 34 of the present embodiment are configured by the high-refractive layer 71H with a high refractive index and the low-refractive layer 71L lower in refractive index than the high-refractive layer 71H being alternately laminated.

As a result, as in the case of the first embodiment, the first filter 20 and the second filter 30 are capable of transmitting light having a plurality of peak wavelengths corresponding to the dimensions of the first gap G1 and the second gap G2 and the plurality of peak wavelengths appear in, for example, the wide measurement wavelength range from the visible light range to the near infrared range. Accordingly, it is possible to disperse and transmit light having a desired target wavelength from a wide measurement wavelength range with high accuracy by setting the first peak wavelength as one of the plurality of peak wavelengths output from the first filter 20 and the second peak wavelength as one of the plurality of peak wavelengths output from the second filter 30 to the target wavelengths.

### MODIFICATION EXAMPLES

It should be noted that the present disclosure is not limited to the embodiments described above and modifications, improvements, and so on within the scope in which the object of the present disclosure can be achieved are included in the present disclosure.

### Modification Example 1

Illustrated in the first embodiment is an example in which the optical body is a laminated body and the first movable reflective film 23, the first fixed reflective film 24, the second movable reflective film 33, and the second fixed reflective film 34 are configured by laminated bodies with different design center wavelengths being laminated. In addition, illustrated in the second embodiment is an example in which the optical body is the one-layer dielectric layer 71 and the first movable reflective film 23, the first fixed reflective film 24, the second movable reflective film 33, and the second fixed reflective film 34 are configured by the layers 71 with different design center wavelengths being laminated.

In contrast, a laminated body may constitute the first movable reflective film 23 and the first fixed reflective film 24 constituting the first filter 20 and the dielectric layer 71 may constitute the second movable reflective film 33 and the second fixed reflective film 34 constituting the second filter 30. Alternatively, the dielectric layer 71 may constitute the first movable reflective film 23 and the first fixed reflective film 24 constituting the first filter 20 and a laminated body may constitute the second movable reflective film 33 and the second fixed reflective film 34 constituting the second filter 30.

### Modification Example 2

Illustrated in the embodiments described above is an example in which the design center wavelength of the laminated body or the layer 71 constituting the first movable reflective film 23 and the first fixed reflective film 24 of the first filter 20 is different from the design center wavelength of the laminated body or the layer 71 constituting the second movable reflective film 33 and the second fixed reflective film 34 of the second filter 30.

In contrast, the design center wavelength of the laminated body or the layer 71 constituting the first movable reflective film 23 and the first fixed reflective film 24 may be equal to the design center wavelength of the laminated body or the layer 71 constituting the second movable reflective film 33 and the second fixed reflective film 34. For example, three laminated bodies that are 900 nm, 600 nm, and 400 nm in design center wavelength may constitute the first movable reflective film 23 and the first fixed reflective film 24 and three laminated bodies that are 900 nm, 600 nm, and 400 nm in design center wavelength may constitute the second movable reflective film 33 and the second fixed reflective film 34.

In this case, the controller 50 makes the peak wavelength to be adjusted to the target wavelength different between the first filter 20 and the second filter 30. For example, when 700 nm light is transmitted from the optical filter 10, the controller 50 sets the first peak wavelength in the transmission characteristics of the first filter 20 as the first peak wavelength, sets the second peak wavelength in the transmission characteristics of the second filter 30 as the second peak wavelength, and adjusts the first gap G1 and the second gap G2 such that the first peak wavelength and the second peak wavelength are 700 nm as a target wavelength. As a result, the peak wavelength other than the target wavelength that is transmitted through the first filter 20 and the peak wavelength other than the target wavelength that is transmitted through the second filter 30 become different from each other and only the light that is centered on the target wavelength can be transmitted from the optical filter 10 as in the case of the embodiments.

### Modification Example 3

Illustrated in the first embodiment is an example in which the same material constitutes the first high-refractive layer 61H, the second high-refractive layer 62H, and the third high-refractive layer 63H and the same material constitutes the first low-refractive layer 61L, the second low-refractive layer 62L, the third low-refractive layer 63L, the first connecting layer 67A, and the second connecting layer 67B. In contrast, different materials may constitute the first high-refractive layer 61H, the second high-refractive layer 62H, and the third high-refractive layer 63H and different materials may constitute the first low-refractive layer 61L, the second low-refractive layer 62L, the third low-refractive layer 63L, the first connecting layer 67A, and the second connecting layer 67B.

In addition, different materials may constitute the two first high-refractive layers 61H constituting the first laminated body 61. The same applies to the second laminated body 62 and the third laminated body 63, and different materials may constitute the two second high-refractive layers 62H and different materials may constitute the two third high-refractive layers 63H.

Further, although an example in which two first high-refractive layers 61H and one first low-refractive layer 61L constitute the first laminated body 61 has been illustrated, a plurality of the first low-refractive layers 61L may be provided in another example. In this case, different materials may constitute the first low-refractive layers 61L. It should be noted that the same applies to the second laminated body 62 and the third laminated body 63.

In other words, the dielectric layer that constitutes the laminated body is not particularly limited in terms of number and material insofar as the first laminated body 61, the second laminated body 62, and the third laminated body 63 have a configuration in which a high-refractive layer and a low-refractive layer lower in refractive index than the high-refractive layer are alternately laminated and the optical film thickness of each layer is set to ¼ of the design center wavelength set for each of the laminated bodies 61, 62, and 63 (first design center wavelength λ₁, second design center wavelength λ₂, and third design center wavelength λ₃).

It should be noted that the same applies to the fourth high-refractive layer 64H, the fifth high-refractive layer 65H, the sixth high-refractive layer 66H, the fourth low-refractive layer 64L, the fifth low-refractive layer 65L, the sixth low-refractive layer 66L, the third connecting layer 68A, and the fourth connecting layer 68B constituting the second movable reflective film 33 and the second fixed reflective film 34.

The same applies to the second embodiment, and the material constituting each high-refractive layer 71H and the material constituting each low-refractive layer 71L may be different from each other insofar as the high-refractive layer 71H and the low-refractive layer 71L are alternately laminated. The film thickness may be set such that the optical film thickness of each layer 71 is ¼ of the design center wavelength set for each layer 71.

### Modification Example 4

Connecting layers (first connecting layer 67A, second connecting layer 67B, third connecting layer 68A, and fourth connecting layer 68B) interconnecting laminated bodies have been exemplified in the first embodiment. In contrast, the laminated body may be directly laminated on the laminated body with the connecting layers not provided.

### Modification Example 5

The present disclosure is not limited to the first embodiment exemplifying a configuration in which the first filter 20 is disposed on the measurement light incident side in the optical filter 10 and the second filter 30 is disposed so as to face the light receiver 40.

For example, the optical filter 10 may have a configuration in which the second filter 30 is positioned on the measurement light incident side and the first filter 20 is disposed so as to face the light receiver 40.

### Modification Example 6

The present disclosure is not limited to the first and second embodiments in which the spectroscopic measuring device 1 that receives the light transmitted through the optical filter 10 with the light receiver 40 is exemplified as an electronic device. For example, the electronic device may be a light source device that emits light dispersed by the optical filter 10 toward an object.

### Overview of Present Disclosure

An optical filter according to a first aspect of the present disclosure includes: a first filter including a pair of first reflective films facing each other via a first gap and a first gap changer changing a gap between the pair of first reflective films; and a second filter including a pair of second reflective films facing each other via a second gap and a second gap changer changing a gap between the pair of second reflective films with the pair of second reflective films disposed on an optical path of light transmitted through the pair of first reflective films, in which each of the first reflective film and the second reflective film is configured by a plurality of optical bodies being laminated, the optical body has reflection characteristics of reflecting light centered on a predetermined design center wavelength, and the design center wavelength is different in each of the optical bodies.

As a result, the first filter is capable of transmitting light having a plurality of peak wavelengths corresponding to the dimension of the first gap and the peak wavelength appears in a wide measurement wavelength range from the visible light range to the near infrared range. The same applies to the second filter, and the second filter is capable of transmitting light having a plurality of peak wavelengths corresponding to the dimension of the second gap and the peak wavelength appears in a wide measurement wavelength range from the visible light range to the near infrared range. In addition, the design center wavelength of each optical body constituting the second reflective film is different from the design center wavelength of each optical body constituting the first reflective film, and thus each peak wavelength in the first filter and the peak wavelength in the second filter are different from each other.

Accordingly, the first gap is adjusted such that one of the plurality of peak wavelengths of the first filter becomes the target wavelength and the second gap is adjusted such that one of the plurality of peak wavelengths of the second filter becomes the target wavelength. As a result, the peak wavelengths other than the target wavelengths in the first filter and the second filter do not overlap, and thus the light of these peak wavelengths is not transmitted through the optical filter and only the light centered on the target wavelength is transmitted through the optical filter.

In addition, in this aspect, the half-value width at each peak wavelength in the spectral characteristics of the first filter and the second filter is sufficiently smaller than in the case of using a Fabry-Perot etalon using a metal film as a reflective film and the wavelength resolution is very high. Accordingly, light of the target wavelength can be transmitted from the optical filter with high resolution.

As described above, the optical filter of this aspect is capable of dispersing and transmitting light having a desired target wavelength from a wide measurement wavelength range with high accuracy.

In the optical filter of this aspect, it is preferable that the optical body constituting the first reflective film and the second reflective film is configured by a laminated body where a high-refractive layer and a low-refractive layer lower in refractive index than the high-refractive layer are alternately laminated and an optical film thickness of the high-refractive layer and an optical film thickness of the low-refractive layer are film thicknesses based on the design center wavelength set for each of the optical bodies.

By using a laminated body as the optical body as described above, it is possible to configure the first filter and the second filter having spectral characteristics in which a plurality of peak wavelengths appear evenly with respect to a wide measurement wavelength range.

It is preferable that the optical filter of this aspect further includes a connecting layer connecting a pair of the laminated bodies adjacent to each other and an optical film thickness of the connecting layer is a film thickness based on an average of the design center wavelengths of the pair of laminated bodies sandwiching the connecting layer.

As a result, the difference in design center wavelength between the laminated bodies can be leveled by the connecting layer and it is possible to obtain spectral characteristics in which a plurality of peak wavelengths are substantially even.

In the optical filter of this aspect, the first reflective film and the second reflective film may be configured by the optical body configured by a high-refractive layer with a high refractive index and the optical body configured by a low-refractive layer lower in refractive index than the high-refractive layer being alternately laminated.

As a result, as in the case of the aspect, the first filter and the second filter are capable of transmitting light having a plurality of peak wavelengths corresponding to the dimensions of the first gap and the second gap and it is possible to obtain spectral characteristics in which the plurality of peak wavelengths appear in, for example, the wide measurement wavelength range from the visible light range to the near infrared range.

In the optical filter of this aspect, it is preferable that the design center wavelength of each of the optical bodies constituting the first reflective film and the design center wavelength of each of the optical bodies constituting the second reflective film are different from each other.

As a result, the peak wavelength of the light transmitted through the first filter and the peak wavelength of the light transmitted through the second filter are different from each other. Accordingly, when the first gap and the second gap are changed such that one of the plurality of peak wavelengths of the first filter and one of the plurality of peak wavelengths of the second filter become the target wavelengths, the peak wavelengths other than the light of the target wavelength are not transmitted and only the light in a narrow band centered on the target wavelength can be transmitted.

In the optical filter of this aspect, it is preferable that the design center wavelength of the optical body constituting the first reflective film becomes shorter as the first gap is approached and the design center wavelength of the optical body constituting the second reflective film becomes shorter as the second gap is approached.

As a result, the peak wavelength of the light transmitted through the first filter appears substantially uniform in the measurement wavelength range, the peak wavelength of the light transmitted through the second filter appears substantially uniform in the measurement wavelength range, and light can be transmitted from the optical filter at a desired wavelength in a wide measurement wavelength range.

An electronic device according to a second aspect of the present disclosure includes: the optical filter according to the first aspect; and a controller controlling the first gap changer and the second gap changer, in which the controller controls the first gap changer such that a first peak wavelength as one of a plurality of peak wavelengths transmitted through the first filter is included in a target wavelength range centered on a desired target wavelength and controls the second gap changer such that a second peak wavelength as one of a plurality of peak wavelengths transmitted through the second filter is included in the target wavelength range and a peak wavelength other than the first peak wavelength transmitted through the first filter and a peak wavelength other than the second peak wavelength transmitted through the second filter are different from each other.

As a result, the light of the target wavelength transmitted through the first filter and the second filter can be transmitted with high wavelength resolution and the target wavelength can be selected in a wide measurement wavelength range from the visible light range to the near infrared range.

In the electronic device of this aspect, the controller controls the first gap changer and the second gap changer such that the first peak wavelength and the second peak wavelength have a difference of 10 nm or less.

Since the difference between the first peak wavelength and the second peak wavelength is 10 nm or less as described above, light of the target wavelength can be transmitted from the optical filter 10 with a transmittance of 10% or more.

What is claimed is:

1. An optical filter comprising:
a first filter including a pair of first reflective films facing each other via a first gap and a first actuator changing a gap between the pair of first reflective films; and
a second filter including a pair of second reflective films facing each other via a second gap and a second actuator changing a gap between the pair of second reflective films with the pair of second reflective films disposed on an optical path of light transmitted through the pair of first reflective films, wherein
each of the first reflective film and the second reflective film is configured by a plurality of optical bodies being laminated, and
the optical body has reflection characteristics of reflecting light centered on a predetermined design center wavelength, and the design center wavelength is different in each of the optical bodies.

2. The optical filter according to claim 1, wherein
the optical body constituting the first reflective film and the second reflective film is configured by a laminated body where a high-refractive layer and a low-refractive layer lower in refractive index than the high-refractive layer are alternately laminated and an optical film thickness of the high-refractive layer and an optical film thickness of the low-refractive layer are film thicknesses based on the design center wavelength set for each of the optical bodies.

3. The optical filter according to claim 2, further comprising:
a connecting layer connecting the pair of laminated bodies adjacent to each other, wherein
an optical film thickness of the connecting layer is a film thickness based on an average of the design center wavelengths of the pair of laminated bodies sandwiching the connecting layer.

4. The optical filter according to claim 1, wherein
the first reflective film and the second reflective film are configured by the optical body configured by a high-refractive layer with a high refractive index and the optical body configured by a low-refractive layer lower in refractive index than the high-refractive layer being alternately laminated.

5. The optical filter according to claim 1, wherein
the design center wavelength of each of the optical bodies constituting the first reflective film and the design center wavelength of each of the optical bodies constituting the second reflective film are different from each other.

6. The optical filter according to claim 1, wherein
the design center wavelength of the optical body constituting the first reflective film becomes shorter as the first gap is approached, and
the design center wavelength of the optical body constituting the second reflective film becomes shorter as the second gap is approached.

7. An electronic device comprising:
the optical filter according to claim 1; and
a controller controlling the first actuator and the second actuator, wherein
the controller controls the first actuator such that a first peak wavelength as one of a plurality of peak wavelengths transmitted through the first filter is included in a target wavelength range centered on a desired target wavelength and controls the second actuator such that a second peak wavelength as one of a plurality of peak wavelengths transmitted through the second filter is included in the target wavelength range and a peak wavelength other than the first peak wavelength transmitted through the first filter and a peak wavelength other than the second peak wavelength transmitted through the second filter are different from each other.

8. The electronic device according to claim 7, wherein
the controller controls the first actuator and the second actuator such that the first peak wavelength and the second peak wavelength have a difference of 10 nm or less.
